(19) United States
(12) Patent Application Publication
(10) Pub. No.: US 2025/0115085 A1
(43) Pub. Date: Apr. 10, 2025

(54) TOW HITCH ATTACHMENT

(71) Applicant: Little Bull LLC, Rolla, MO (US)

(72) Inventors: Donald Glenn HARROP, JR., Rolla, MO (US); Patricia HARROP, Rolla, MO (US)

(21) Appl. No.: 18/906,910

(22) Filed: Oct. 4, 2024

Related U.S. Application Data
(60) Provisional application No. 63/588,172, filed on Oct. 5, 2023.

(51) Int. Cl. B60D 1/06; B60D 1/52

(52) U.S. Cl. CPC B60D 1/065; B60D 1/52

(57) ABSTRACT

A mounting assembly for a tow hitch having a pair of tubes, one of the pair of tubes arranged to be inserted within the other of the pair of tubes and selectively telescope therein, a C-shaped clamp extending from one of the pair of tubes, and a pair of attachment arms extending from one of the pair of tubes without the C-shaped clamp, where the C-shaped clamp and the pair of attachment arms are adapted to be selectively translated together, thereby securing a planar object within the C-clamp via the pair of attachment arms abutting the planar object. The planar object may be a rear blade or a box blade, or an edge of another implement.

### CROSS-REFERENCE TO RELATED APPLICATIONS

This application claims priority pursuant to 35 U.S.C. 119 (e) to U.S. Provisional Application No. 63/588,172, filed Oct. 5, 2023, which application is incorporated herein by reference in its entirety.

### FIELD

The present invention relates to a tow hitch attachment, specifically an attachment arranged to removably engage a tractor blade, specifically, one or more of a rear blade, a box blade, or other similar implement, e.g., a loader bucket, a digger bucket, a forklift attachment, etc.

### BACKGROUND

Tractors, although commonly associated with farms and agricultural applications, are not exclusive to these uses. In residential settings, tractors, of various sizes are employed for a variety of uses. John Deere and Kubota are two tractor manufacturers and suppliers, and both companies offer known-in-the-art, three-point attachment mechanisms, or “three-point hitch” proximate the rear end of the tractors.

The three-point hitch is a widely used type of hitch for attaching ploughs and other implements to an agricultural or industrial tractor, even some residential ride-on mowers and/or tractors include three-point hitches. The three points resemble either a triangle, or the letter A.

The three-point hitch is made up of several components working together. These include the tractor's hydraulic system, attaching points, the lifting arms, and stabilizers. Three-point hitches are composed of three movable arms. The two lower arms—the hitch lifting arms—are controlled by the hydraulic system, and provide lifting, lowering, and even tilting to the arms. The upper center arm-called the top link—is movable, but is usually not powered by the tractor's hydraulic system. Each arm has an attachment device to connect implements to the hitch. Each hitch has attachment holes for attaching implements, and the implement has posts that fit through the holes. The implement is secured by placing a pin on the ends of the posts.

The hitch lifting arms are powered by the tractor's hydraulic system. The hydraulic system is controlled by the operator, and usually a variety of settings are available. A draft control mechanism is often present in modern three-point hitch systems. The draft of the implement, the amount of force it is taking to pull the implement, is sensed on the top link and the hydraulic system automatically raises the arms slightly when the draft increases and lowers the arms when the draft decreases.

A common attachment for the three-point hitch is a rear blade, or grader blade, which fits onto the three-point hitch. Typically, the rear blade may be adjusted for pitch and angle of the blade, giving the user control of how much the blade may or may not cut into the ground along with adjusting where the debris or dirt will move. Some examples of rear blades may be found here:
a. https://homesteadimplements.com/6-way-articulating-back-blade-pinnacle-series/?setCurrencyId=1&sku=HI-P-ABB-72-G&gclid=CjwKCAjw9-60BhBaEiwAHv1QvEGNr89QXNcLta2Ye-Tvhi4-mau-qAc6_qjik5NvCiU10QGu5lsfhRoCn3UQAvD_BWE
b. https://www.tractorsupply.com/tsc/product/countyline-grader-blade-6-ft-2130039?store=656&cid=Shopping-Google-Local_Feed&utm_medium=Google&utm_source=Shopping&utm_campaign=&utm_content=Local_Feed&gclid=CjwKCAjw9-60BhBaEiwAHv1QvHcYpkHLK0a_2dTdBRafHxT3geISKAXfMIa6nn9HhrY8T7eb7Wsm0BoCX QQQAvD_BWE

One embodiment of a rear blade or a grader blade is illustrated in FIG. 1, described further, infra.

Another common attachment for the three-point hitch is a box blade, which also fits onto the three-point hitch. A box blade with scarifiers essentially is a three-sided metal box, with front and rear scraping blades that sit across a bottom of a rear panel. It's used primarily for spreading material like soil or gravel, and for grading, leveling, or backfilling an expansive area of land for a driveway, lawn, garden, building site, etc. Each scarifier may be configured as an angled metal tooth, forming a plurality of scarifiers, mounted in a row on a crossbeam across an upper width of the box blade. When locked down in operating position, they dig into and break up hard ground so it can be shaped to your need. An example of a box blade may be found here:
a. https://palletforks.com/products/3-point-box-blade-scraper?variant=47327912132912&gad_source=1&gclid=Cj0KCQjw3vO3BhCq ARIsAEWblcDIAbBIJM9y0_RvEIWW2uK-v2TznEKB-FDdChcirwfxJ5F2P8qgAc0aAg0nEALw_wcB

One embodiment of a box blade is illustrated in FIG. 10, described further, infra.

Therefore, there is a long-felt need for an apparatus that easily and removably attaches to one or more of a rear blade or a box blade, which apparatus is arranged with a tow hitch having a hitch ball, allowing the rear blade to accommodate towing, vis-à-vis, the apparatus.

### SUMMARY

The present invention is generally related to a mounting assembly for a tow hitch, comprising a main body having a hitch tongue removably secured to and extending from a first end, the hitch tongue having an aperture arranged therein, a pair of attachment arms extending downwardly from the main body and arranged proximate the first end, and a clamp secured to the main body and proximate a second end of the main body, the clamp having a channel therein, the channel having an opening substantially facing a downward direction, wherein the clamp and the pair of attachment arms are spaced apart and a distance therebetween is adjustable, wherein the aperture of the hitch tongue is arranged to accept a hitch-ball therein. In a preferred embodiment, the clamp is arranged to accept an edge of a blade therein and the attachment arms are arranged to abut a surface of the blade, thereby frictionally and removably securing the main body to the blade. In a preferred embodiment, the aforementioned blade is a rear blade.

In some configurations, the aforementioned main body of the mounting assembly for the tow hitch may comprise a clamp section having a first tube and a first engagement cavity therein, the clamp fixedly secured to the first tube, a medial section having a second tube and a second engagement cavity therein, the attachment arms extending from the second tube, and, a hitch section having the hitch tongue extending therefrom, where the second tube of the medial section is arranged to be slidably and removably secured at least partially within the first engagement cavity; and, the hitch section is arranged to be slidably and removably secured at least partially within the second engagement cavity.

In other embodiments, the present invention generally comprises a mounting assembly for a tow hitch having a first tube having a C-shaped clamp extending therefrom, the C-shaped clamp having a pair of attachment fasteners removably secured thereto, a second tube arranged to telescopingly and removably insert into the first tube, the second tube having a pair of attachment arms extending therefrom, a hitch body having a first end and second end, the first end arranged to telescopingly and removably insert into the second tube, the second end having a hitch-ball aperture arranged proximate the second end, the hitch-ball aperture having a hitch-ball removably inserted therein.

In other arrangements, the C-shaped clamp of the aforementioned mounting assembly for a tow hitch is arranged to accept an edge of a tractor blade therein and the aforementioned pair of attachment arms are arranged to abut a first surface of the tractor blade, removably securing the mounting assembly for a tow hitch thereto.

In further configurations, the aforementioned pair of attachment fasteners of the C-shaped clamp are operatively arranged to frictionally secure the edge of the tractor blade within the C-shaped clamp when the pair of attachment fasteners are abutting a second surface of the tractor blade.

In some arrangements, the aforementioned mounting assembly for a tow hitch may be configured such that the first tube includes a first plurality of apertures and the second tube includes a second plurality of apertures, where a first securement pin locks the second tube within the first tube when arranged within a colinear pair of the first plurality of apertures and a colinear pair of the second plurality of apertures. The aforementioned mounting assembly for a tow hitch may be further configured such that the second tube includes a first pair of apertures arranged opposite the second plurality of apertures and the hitch body includes a second pair of apertures proximate the first end, wherein a second securement pin locks the first end of the hitch body within the second tube when arranged within the first pair of apertures and the second pair of apertures.

In even further embodiments, the present invention may comprise a mounting assembly for a tow hitch, the mounting assembly including a main body having a first end and a second end, the main body having at least one engagement cavity therein, a pair of attachment arms extending downwardly from the main body and arranged proximate the first end, and a clamp secured to the main body and proximate a second end of the main body, the clamp having a channel therein, the channel having an opening and substantially facing a downward direction, wherein the clamp and the pair of attachment arms are spaced apart and a distance therebetween is adjustable.

In other embodiments, the engagement cavity is arranged to removably accept a hitch tongue therein.

In some configurations the clamp is arranged to accept an edge of a substantially planar object therein and the attachment arms are arranged to abut a surface of the substantially planar object, thereby frictionally and removably securing the main body to the substantially planar object. The substantially planar object may be a rear blade.

In other arrangements the main body comprises: a clamp section having a first tube and a first engagement cavity therein, the clamp fixedly secured to the first tube; a medial section having a second tube and a second engagement cavity therein, the attachment arms extending from the second tube; and, wherein the second tube of the medial section is arranged to be slidably and removably secured at least partially within the first engagement cavity.

In further configurations, the second engagement cavity is further arranged to removably accept a body of a hitch tongue therein.

In other aspects, the present invention may generally comprise a mounting assembly for a tow hitch, the mounting assembly may include a pair of tubes, one of the pair of tubes arranged to be inserted within the other of the pair of tubes and selectively telescope therein, a C-shaped clamp extending from one of the pair of tubes, and a pair of attachment arms extending from one of the pair of tubes without the C-shaped clamp, where the C-shaped clamp and the pair of attachment arms are adapted to be selectively translated together, thereby securing a planar object within the C-clamp via the pair of attachment arms abutting the planar object.

In some embodiments, the aforementioned mounting assembly for a tow hitch may further comprise a hitch body having a first end and second end, the first end arranged to telescopingly and removably insert into at least one tube of the pair of tubes, the second end having a hitch-ball aperture arranged proximate the second end, where the hitch-ball aperture is adapted to removably accept a hitch-ball therein.

In other possible configurations, the aforementioned mounting assembly for a tow hitch may further include a second pair of attachment arms extending from one of the pair of tubes, the C-shaped clamp affixed to the second pair of attachment arms.

In some designs, the second pair of attachment arms of the aforementioned mounting assembly for a tow hitch may be angled.

In further embodiments, the C-shaped clamp may include a pair of attachment fasteners removably secured thereto.

In some configurations, the aforementioned tow hitch recited may further comprise a distal tube attached to and arranged substantially between the second pair of attachment arms proximate distal ends of the second pair of attachment arms, the distal tube adapted to telescopingly and removably accept one or more of the hitch body therein or another tube therein.

In other embodiments, the C-shaped clamp includes an opening of a channel within the clamp, where the opening of the channel of the C-shaped clamp is substantially parallel to one or more openings of the pair of tubes of the aforementioned mounting assembly for a tow hitch.

In further possible designs, the aforementioned mounting assembly for a tow hitch further comprises at least one securement pin, the securement pin arranged to be inserted within a colinear pair of apertures of a plurality of apertures arranged within both of the pair of tubes, thereby securing one of the pair of tubes within the other of the pair of tubes.

An object of the present invention is to provide a pair of receivers, e.g., tubes, where one of the receivers is arranged to at least partially mate within the other receiver. One of the receivers has at least a pair of arms extending distally therefrom, and the other receiver has at least a clamp connected thereto, where the receivers are arranged to translate, in a selectable and locking manner, thereby decreasing or increasing, a distance between the clamp and the arms, allowing the clamp and the arms to substantially secure to an implement, e.g., a box blade, rear blade, bucket, etc., or to be released from the implement. Further, at least one of the pair of receivers is adapted to accept an implement therein, where the implement may comprise one or more of a ball mount (hitch mount) arranged to accept a ball therein (hitch ball), or another implement that is arranged to be removably secured within a hitch receiver.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 illustrates an exemplary embodiment of a rear blade;

FIG. 2 illustrates a partial front perspective view of the rear blade taken generally from DETAIL 1 in FIG. 1 and the present invention attached thereto;

FIG. 3 illustrates a rear perspective view of FIG. 2;

FIG. 4 illustrates a right-side view of FIG. 2;

FIGS. 5 and 6 illustrate exploded views of the present invention shown in FIG. 2;

FIG. 7 is a rear perspective view of the present invention shown in FIG. 2;

FIG. 8 is a left-side view of FIG. 7;

FIG. 9 is a right-side view of FIG. 8;

FIG. 10 illustrates an exemplary embodiment of a box blade having an embodiment of the present invention attached thereto;

FIG. 11 illustrates an enlarged perspective view of the present invention taken generally from FIG. 10;

FIG. 12 illustrates a side view of the invention shown in FIG. 11; and,

FIGS. 13A and 13B generally illustrate exploded views of the invention shown in FIG. 11.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. As such, those in the art will understand that any suitable material, now known or hereafter developed, may be used in forming the present invention described herein.

Unless defined otherwise, all technical and scientific terms used herein have the same meaning as commonly understood to one of ordinary skill in the art to which this disclosure pertains. It should be understood that any methods, devices or materials similar or equivalent to those described herein, or understood to one having skill in the art within, can be used in the practice or testing of the example embodiments.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The word “example” or “exemplary” is used herein to mean “serving as an example, instance, or illustration.” Any implementation described herein as “exemplary” is not necessarily to be construed as preferred or advantageous over other implementations.

The terms, “having”, “has”, “including”, “includes” are intended to be substantially synonymous with the terms “comprising” and/or “comprises” and/or “comprise”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

It should be noted that the term “tube” is not intended to be restrictive on a particular shape, e.g., cylindrical, rather it should be interpreted to mean that a particular member, regardless of the shape, is hollow and has respective open ends.

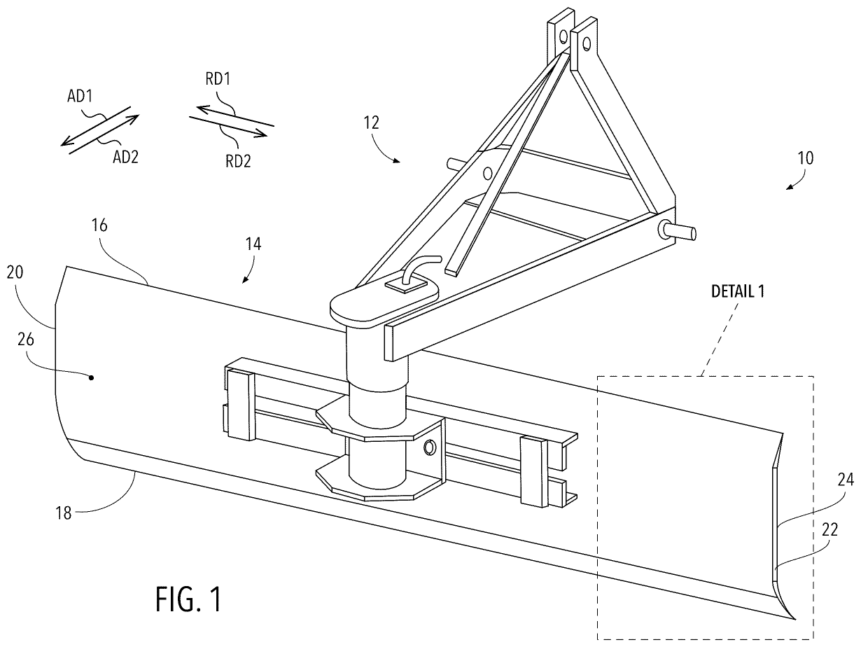

Adverting now to the figures, FIG. 1 generally illustrates a perspective view of an exemplary embodiment of rear blade 10. As discussed supra, rear blade 10 is arranged to connect to a three-point hitch of a tractor, or other vehicle, via three-point hitch attachment apparatus 12. Blade 14 is at least pivotably connected to three-point hitch attachment apparatus 12. In some embodiments, blade 14 comprises top edge 16, bottom edge 18, side edge 20, side edge 22, first surface 24 and second surface 26. In some arrangements, blade 14 has two angled sections, the first angled section is bent towards three-point hitch attachment apparatus 12 and arranged proximate top edge 16 and the second section is bent towards three-point hitch attachment apparatus 12 and proximate bottom edge 18.

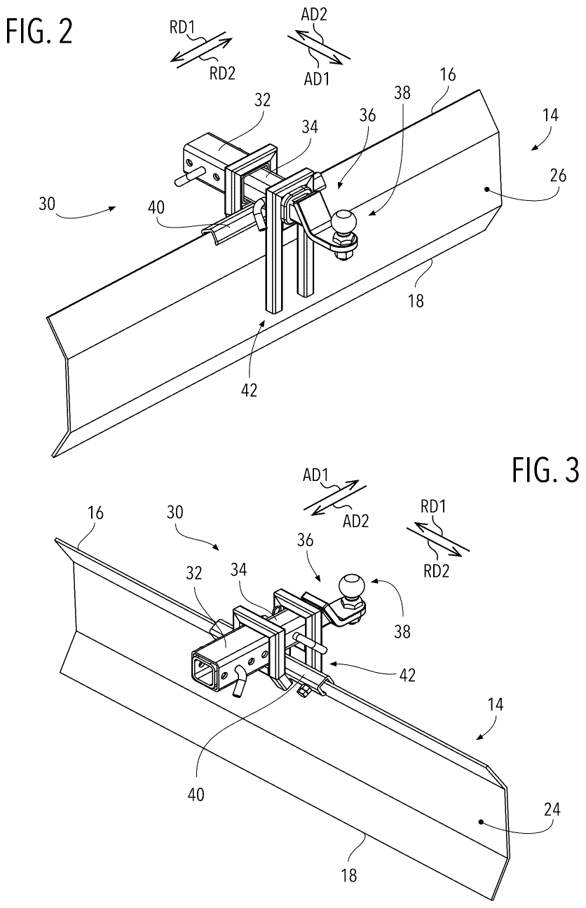

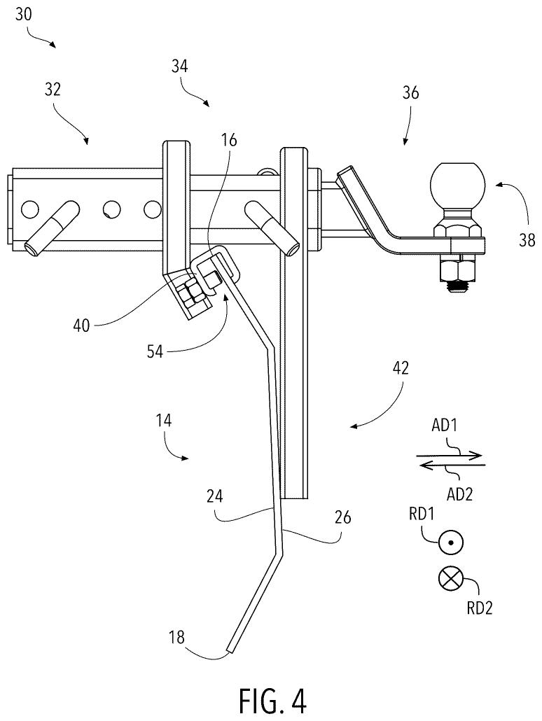

In reference to FIGS. 2 through 4, FIG. 2 is an enlarged view taken generally from DETAIL 1 and showing the present invention, tow hitch attachment 30, engaged with blade 14, where FIGS. 3 and 4 generally illustrate a rear view and side view of FIG. 2, respectively.

In one possible embodiment, tow hitch attachment 30 generally includes at least two main components: clamp section 32 having clamp 40 extending therefrom, and medial section 34 having attachment arms 42 extending therefrom, where in some configurations, tow hitch attachment 30 may also include hitch section 36 having hitch-ball removably attached thereto. It should be noted that hitch section 36 may alternatively comprise a variety of commercially-available hitch tongue bodies that may be removably connected to medial section 34. Clamp section 32, medial section 34, and hitch section 36 are all removably connected, specifically, hitch section 36 is removably connected within medial section 34, and medial section 34 is removably connected within clamp section 32. As shown in FIG. 4, tow hitch attachment 30 is removably engaged to blade 14, where top edge 16 is arranged within channel 54 of clamp 40 and attachment arms 42 are abutting second surface 26 of blade 14.

In a preferred embodiment, clamp section 32 and medial section 34 are telescopingly connected, such that the distance between clamp 40 and attachment arms 42 may be adjusted based on the specific dimensions of blade 14. It should be noted that in alternative arrangements, hitch section 36 and medial section 34 may be configured as a singular component that telescopingly and removably connects within clamp section 32.

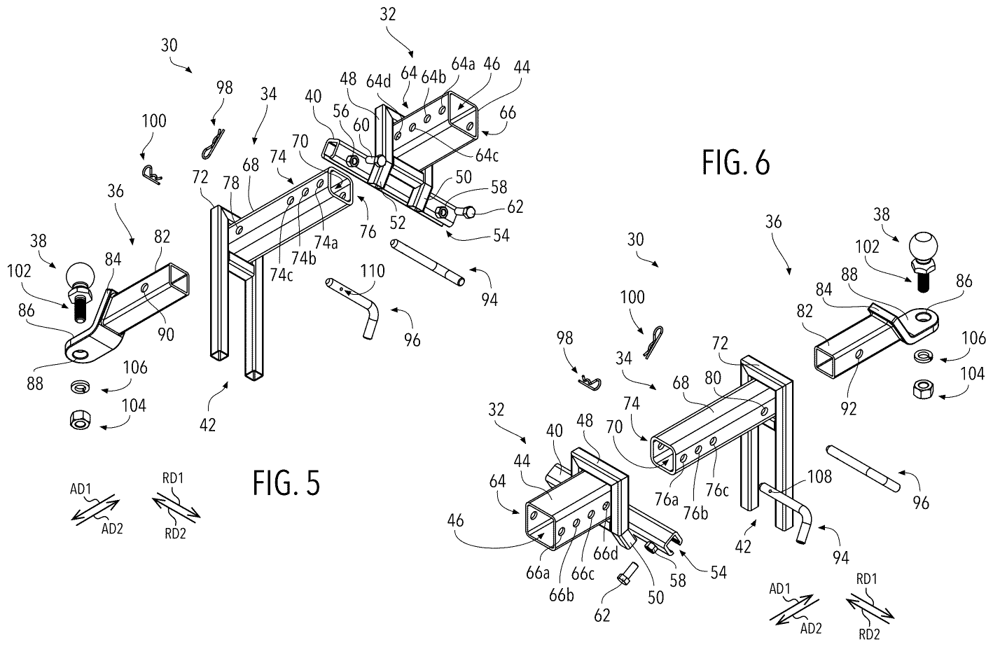

The following description should be taken in view of FIGS. 5 and 6 which illustrate perspective exploded views of tow hitch attachment 30.

In some arrangements, clamp section 32 comprises main body 44 which generally takes a rectangular-like tube configuration having engagement cavity 46 therein. Main body 44, although preferably rectangular in configuration, may take alternative configurations, such as cylindrical. Attachment frame 48 is fixedly secured to main body 44 proximate axial direction AD1 and preferably surrounds the entirety of main body 44 at an end in axial direction AD1.

Angled extension 50 extends from attachment frame 48 at an angle generally in axial direction AD1 and biased towards radial direction RD1. Angled extension 52 extends from attachment 48 at an angle generally in axial direction AD1 and biased towards radial direction RD2. Clamp 40 is fixed to both angled extensions 50 and 52 proximate axial direction AD1. Clamp 40 includes channel 54 having an opening thereto, which opening is angled such that it generally faces attachment arms 42 (See FIG. 4). Fastener apertures 56 and 58 are arranged proximate respective ends of clamp 40 and are in communication with channel 54, i.e., apertures 56 and 58 open into channel 54. In a preferred embodiment, fastener apertures 56 and 58 are threaded. Attachment fasteners 60 and 62 are arranged to removably engage fastener apertures 56 and 58, respectively, such that respective terminating ends of fasteners 60 and 62 may be protruding into channel 54 of clamp 40 (when the fasteners are threaded into channel 54 via their respective apertures)-thereby allowing clamp 40 to removably and frictionally secure blade 14 therein (See FIG. 4). In other words, fasteners 60 and 62 are preferably threaded into apertures 56 and 58 such that the protruding ends are within channel 54 and contact surface 24 of blade 14, sandwiching blade 14 between the protruding ends of fasteners 60 and 62, and clamp 42. In a preferred embodiment, attachment fasteners 60 and 62 are threaded. Main body 44 includes plurality of securement apertures 64 (comprised of securements apertures 64a through 64d) arranged on a face of main body 44 in radial direction RD2, where each of aperture of plurality securement apertures 64 is in communication with engagement cavity 46, i.e., each aperture of plurality securement apertures 64 is open to engagement cavity 46. Main body 44 also includes plurality of securement apertures 66 (comprised of securements apertures 66a through 66d) arranged on a face of main body 44 in radial direction RD1, where each of aperture of plurality securement apertures 66 is in communication with engagement cavity 46, i.e., each aperture of plurality securement apertures 66 is open to engagement cavity 46. It should be noted that, in a preferred embodiment, securement apertures 64a-64d are colinearly arranged with securement apertures 66a-66d, respectively.

In some configurations, medial body 34 comprises main body 68 which generally takes a rectangular-like tube configuration having engagement cavity 70 therein. Main body 68, although preferably rectangular in configuration, may take alternative configurations, such as cylindrical, so long as main body 68 may be removably inserted within engagement cavity 46 of main body 44 of clamp section 32. Thus, in a preferred embodiment, an outer perimeter of main body 68 is less than a perimeter of engagement cavity 46 of main body 44, such that main body 68 may be inserted within main body 44 and may slide therein. Attachment frame 72 is fixedly secured to main body 68 proximate an end facing axial direction AD1 and preferably surrounds the entirety of main body 68. Attachments arms 42 (preferably a pair of arms, as generally illustrated) extend distally, or downwardly, from attachment frame 72. Attachment arms 42 are arranged to abut at least a portion of a surface of a rear blade, or abut at least portion of a planar surface of a rear blade (See FIG. 4). Main body 68 includes plurality of securement apertures 74 (comprised of securements apertures 74a through 74c) arranged on a face of main body 68 facing radial direction RD2, where each of aperture of plurality securement apertures 74 is in communication with engagement cavity 70, i.e., each aperture of plurality securement apertures 74 is open to engagement cavity 70. Main body 68 also includes plurality of securement apertures 76 (comprised of securements apertures 76a through 76c) arranged on a face of main body 68 facing radial direction RD1, where each aperture of plurality securement apertures 76 is in communication with engagement cavity 70, i.e., each aperture of plurality securement apertures 76 is open to engagement cavity 76. It should be noted that in a preferred embodiment, securement apertures 74a-74c are colinearly arranged with securement apertures 76a-76c, respectively, and both pluralities of securement apertures 64 and 66 are arranged proximate an end of main body 68 that faces axial direction AD2. Main body 68 also includes securement apertures 78 and 80, where securement aperture 78 is arranged on a face of main body 68 that faces radial direction RD2 and securement aperture 80 is arranged on a face of main body 68 that faces radial direction RD1. In a preferred embodiment, securements apertures 78 and 80 are spaced apart from pluralities of securement apertures 64 and 66, and are arranged proximate attachment frame 72. Preferably, securement apertures 78 and 80 are colinearly arranged.

In some embodiments, hitch section 36 comprises attachment body 82 which generally is configured as rectangular-like tube, which may be either substantially hollow, as shown, or could be a solid piece. Preferably, an outer perimeter of attachment body 82 is less than a perimeter of engagement cavity 70 of main body 68, such that attachment body 82 may be inserted within main body 68 and may slide therein. Extension 84 is fixedly secured to an end of attachment body 82 which faces axial direction AD1. Hitch tongue 86 extends in axial direction AD1 from extension 84 and includes hitch-ball aperture 88 arranged therein. Securement apertures 90 and 92 are arranged within attachment body 82 proximate an end of attachment body 82 which faces axial direction AD2. In a preferred embodiment, securement apertures 90 and 92 are colinearly arranged. Hitch-ball 38, e.g., a “trailer ball” and/or “tow ball”, is a substantially spherical attachment that allows a trailer tongue to engage tow hitch attachment 30—allowing the trailer tongue to pivot on hitch-ball. In a preferred embodiment, hitch-ball 38 includes threaded portion 102 extending distally therefrom, where threaded portion 102 is arranged to be seated within hitch-ball aperture 88 and secured threadably therein by nut 104. In some arrangements washer 106 is arranged on threaded portion between nut 104 and hitch tongue 86. In other embodiments, hitch-ball aperture 88 may be threaded.

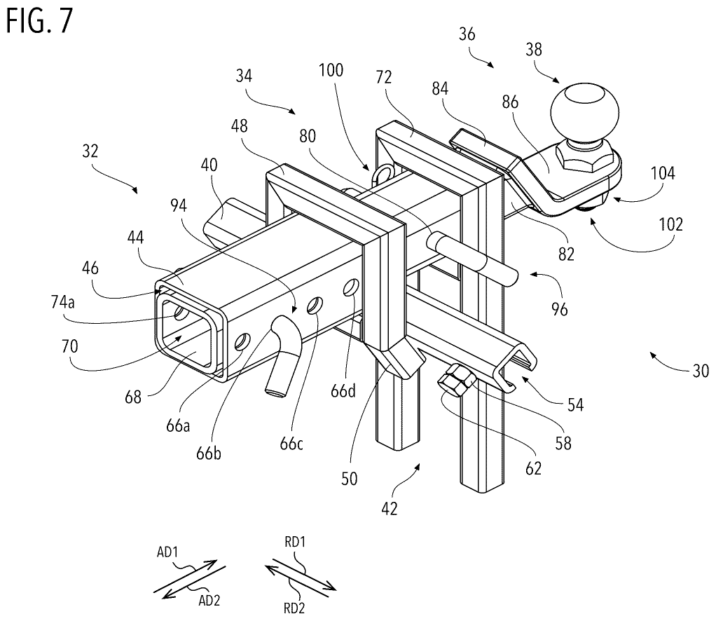

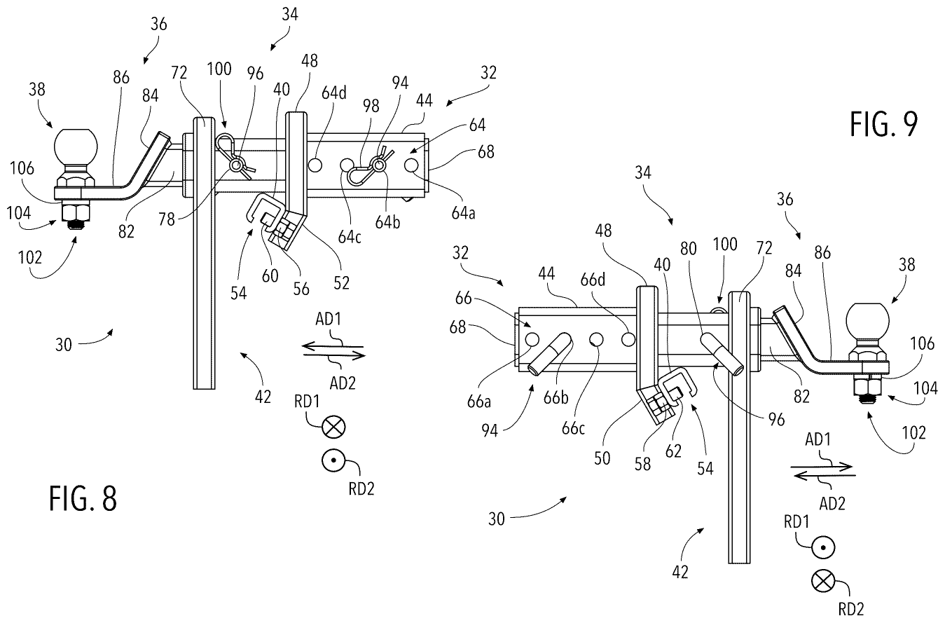

In a preferred arrangement, clamp section 32, medial section 34, and hitch section 36 are removably secured by securement pins 94 and 96, each of which have pin apertures 108 and 110, respectively. Pin apertures 108 and 110 are arranged to accept locking pins 98 and 100 therein respectively (See FIGS. 7-9).

The following description is in reference to FIGS. 7 through 9, which generally show assembled tow hitch attachment 30. The securement apertures, referenced below, are collectively shown in FIGS. 5 and 6, as described supra.

To assemble tow hitch attachment 30, main body 68 of medial section 34 is inserted within engagement cavity 46 of main body 44 of clamp section 32 proximate attachment frame 48. Main body 68 is removably secured within engagement cavity 46 via securement pin 94, wherein securement pin 94 is removably seated within a respective pair of pluralities of securement apertures 64 and 66 of clamp section 32 and also within a respective pair of pluralities of securement apertures 74 and 76, e.g., securement pin 94 is seated within securement apertures 66b, 64b, 74b, and 76b, as shown. Thus, depending on the particular colinear pair of pluralities of securement apertures 64 and 66 of clamp section 32 and the particular colinear pair of pluralities of securement apertures 74 and 76, the distance between attachment arms 42 and clamp 40 is adjustable. Once clamp section 32 and medial section 34 are removably secured, hitch section 36 may be removably secured to medial section 34. Attachment body 82 is inserted within engagement cavity 70 of main body 68 proximate attachment frame 72 and removably secured therein via securement pin 96. Securement pin 96 is removably seated within securement apertures 78 and 80 of main body 68 and also within securement apertures 90 and 92 of attachment body 82, thereby removably connecting hitch section 36 to medial body 34. Securement pin 94 is removably locked within the respective securement apertures via locking pin 98 being frictionally inserted within pin aperture 108 and securement pin 96 is removably locked within the respective securement apertures via locking pin 100 being fictionally inserted within pin aperture 110.

In reference to FIG. 4, when an accessory or implement is engaged to hitch-ball 38 for towing, when blade 14 moves in axial direction AD2, the accessory (when engaged) will pull tow hitch attachment in the opposite direction, axial direction AD1, forcing edge 16 to abut clamp 40 within channel 54 (as blade 14 is directed upwardly into channel 54 because of the angle in which clamp is arranged), thereby forcing surface 26 to abut pair of attachment arms 42 fictionally securing tow hitch attachment 30 to blade 14 (via the generally described force vectors). Thus, when force is applied to blade 14 in axial direction AD2 and force is applied to tow hitch attachment 30 in axial direction AD1, tow hitch attachment 30 is forcibly secured to blade 14 and cannot be removed—the same is true when the respective force directions to blade 14 and tow hitch attachment 30 are reversed. When no force (in either axial directions AD1 and AD2) is applied to blade 14 and no force (in either axial directions AD1 and AD2) is applied to tow hitch attachment 30, tow hitch attachment 30 merely rests on blade 14 and may be easily removed once attachment fasteners 56 and 58 are loosened.

It should be noted that although the present invention is intended to be used with a rear blade implement, modifications are contemplated that would allow the present invention to removably secure to other blade types and/or configurations. For example, the aforementioned clamp may be fixed or adjustably fixed (e.g., pivotably arranged) such that it may engage non-angled blades, i.e., a box blade attachment, described further, infra, an edge of a bucket movably attached to a tractor or the like.

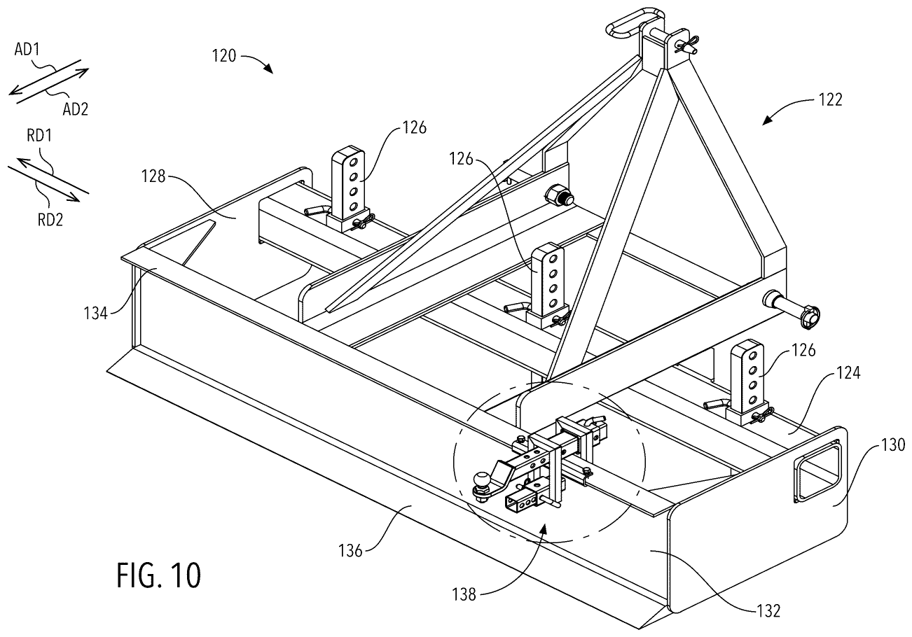

Adverting now to an embodiment of the present invention configured to removably secure to a box blade. At the outset, FIG. 10 generally illustrates a perspective view of an exemplary embodiment of box blade 120. As discussed supra, box blade 120 is arranged to connect to a three-point hitch of a tractor, or other vehicle, via three-point hitch attachment apparatus 122. Support member 124 and plate 132 are secured to three-point hitch apparatus, where side members 128 and 130 are secured to both support member 124 and plate 132, substantially creating a “box-like” configuration of the support member, the plate, and both side members. In some configurations, support member 124 includes a plurality of scarifiers or shanks, e.g., scarifier/shanks 126, extending therefrom. In other embodiments, plate 132 includes top lip 134 extending from a top terminating edge thereof and blade 136 extending from a bottom terminating edge thereof. Top lip 134 is preferably planar and perpendicular to plate 132. As shown, one embodiment of the present invention is removably attached to box blade 120, engaging one or more of plate 132 or top lip 134.

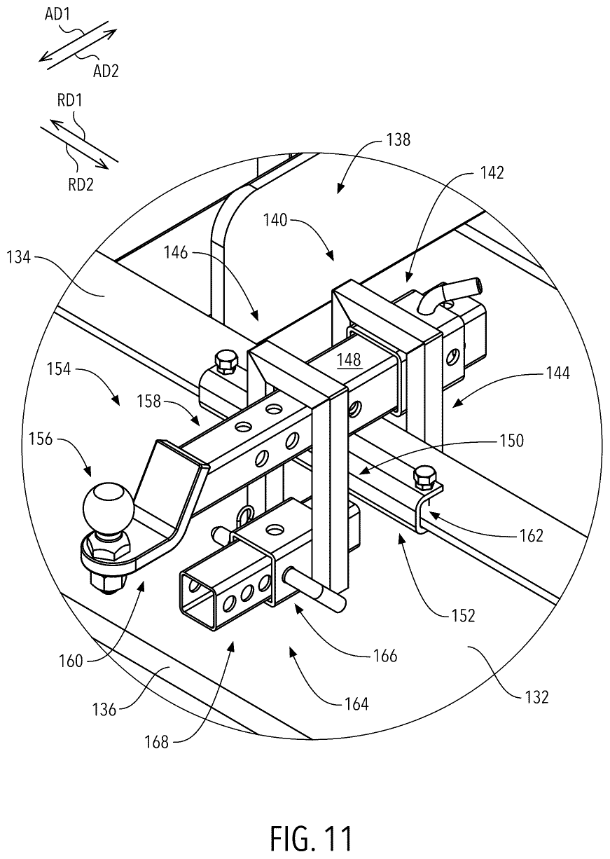

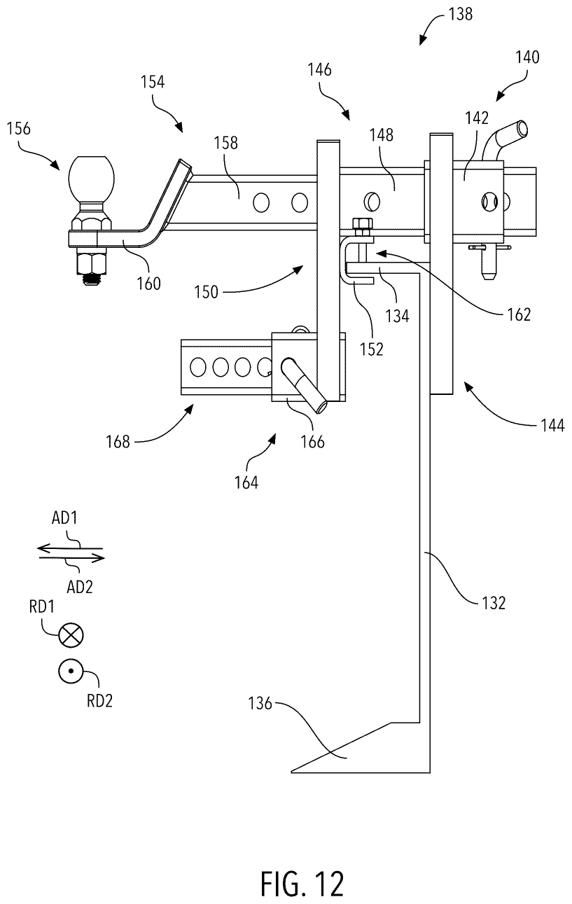

In reference to FIGS. 11 and 12, FIG. 11 is an enlarged view taken generally from FIG. 10 and showing the present invention, tow hitch attachment 138, attached to box blade 120, where FIG. 12 generally illustrate a side view of FIG. 11, respectively.

In one possible embodiment, tow hitch attachment 138 generally includes at least two main components: main tube 140 having first pair of attachment arms 144 extending from body 142, and clamp tube 146 having second pair of attachment arms 150 extending from body 148 and clamp 152 extending from one or more of second pair of attachment arms 150 or body 148, where in some configurations, tow hitch attachment 138 may also include hitch section 154, which may comprise body 158 with hitch tongue 160 extending therefrom, where hitch tongue is arranged to removably accept hitch ball 156 therein. It should be noted that hitch section 154 may alternatively comprise a variety of commercially-available hitch tongue bodies that may be removably connected within one or more of main tube 140 or clamp tube 146. Main tube 140, clamp tube 146, and hitch section 154 are all removably connected, specifically, hitch section 154 is removably connected within one or more of main tube 140 or clamp tube 146, and clamp tube 146 is removably connected within main tube 140. As shown in FIG. 12, tow hitch attachment 138 is removably engaged to box blade 120, specifically one or more of plate 132 or top lip 134, where top lip 134 (or a top edge of plate 132 if top lip 134 isn't present and clamp 152 is rotated approximately 90° such that channel 162 faces downwardly towards blade 136) is arranged within channel 162 of clamp 152 and first pair of attachment arms 144 are abutting at least a surface of plate 132.

In a preferred embodiment, main tube 140 and clamp tube 146 are telescopingly connected, such that the distance between clamp 152 and attachment arms 144 may be adjusted based on the specific dimensions of one or more of plate 132 or front lip 134, thereby frictionally pinching the component or components of box blade 120 therein. It should be noted that in alternative arrangements, hitch section 154 and clamp tube 146 may be configured as a singular component that telescopingly and removably connects within main tube 140.

In other possible configurations, tow hitch attachment 138 may include distal tube 164 affixed between and proximate terminating ends of second pair of attachment arms 150. As shown, distal tube 164 is adapted to telescopingly and removably accept ancillary tube 168 therein, or may be arranged to telescopingly and removably accept body 158 of hitch section 154 therein.

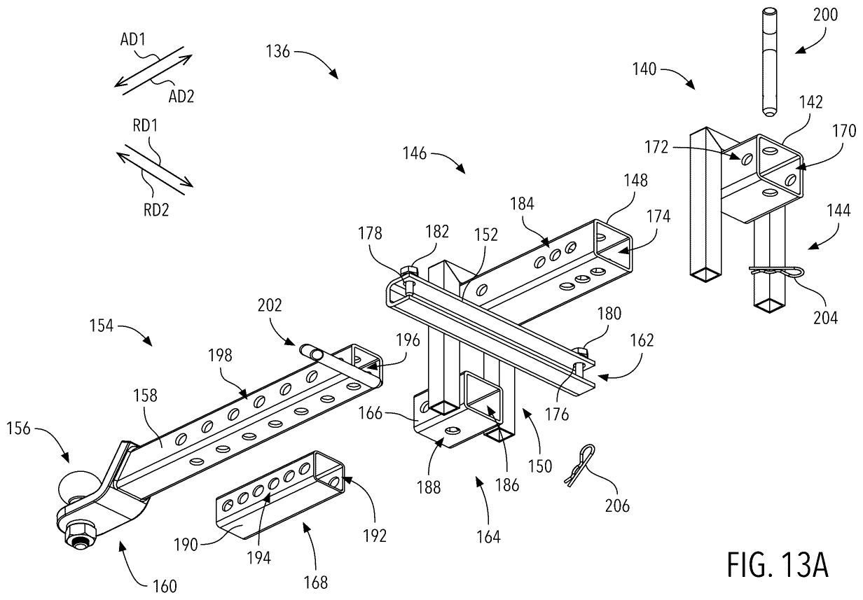

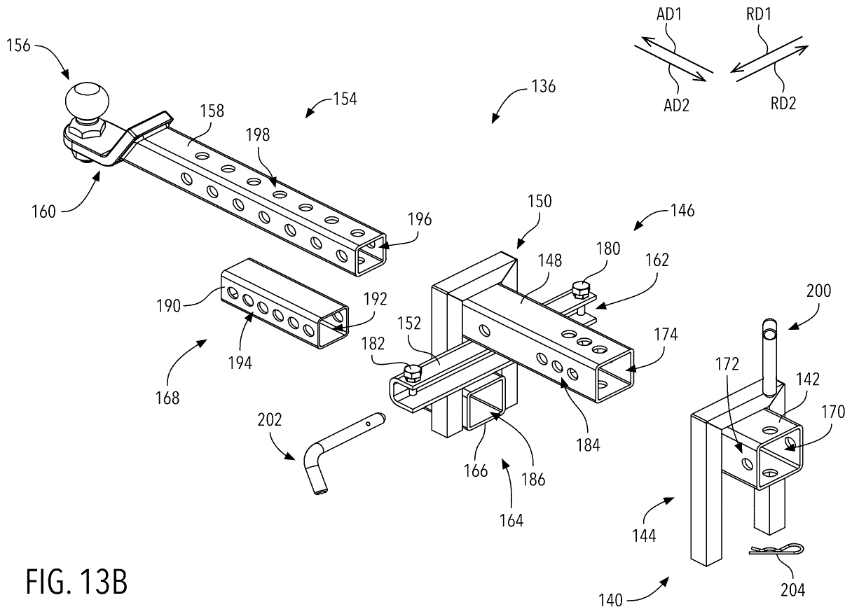

The following description should be taken in view of FIGS. 13A and 13B which illustrate perspective exploded views of tow hitch attachment 138. It should be noted that the various securement apertures and securement pins, described infra, function identically to those of tow hitch attachment 30, described supra. In other words, the engagement securement pins within a particular colinear pair of securement apertures, removable secure at least one tube within another tube.

In some configurations, main tube 140 comprises body 142 which generally takes a rectangular-like tube configuration having engagement cavity 170 therein. Body 142, although preferably rectangular in configuration, may take alternative configurations, such as cylindrical, so long as body 148 of clamp tube 146 may be removably inserted within engagement cavity 170 of body 142 of main tube 140. Thus, in a preferred embodiment, an outer perimeter of body 148 is less than a perimeter of engagement cavity 170 of body 142, such that main body 148 may be inserted within body 142 and may translate therein. First pair of attachment arms 144 is fixedly secured to body 142 proximate an end facing axial direction AD1 and preferably a portion thereof surrounds a majority of body 142. Attachments arms 144 (preferably a pair of arms, as generally illustrated) extend distally, or downwardly, away from body 142. Attachment arms 144 are arranged to abut at least a portion of a surface of plate or blade, or abut at least portion of a surface of a box blade (See FIG. 12). Body 142 includes plurality of securement apertures 172 arranged within respective surfaces of body 142, where each of the securement apertures in communication with engagement cavity 170, i.e., each aperture of plurality securement apertures 172 is open to engagement cavity 170. It should be appreciated that the number and/or position of securement apertures of body 142 is variable and can be altered accordingly in order to allow one or more of clamp tube 146 or hitch section 154 to be telescopingly and removably secured within body 142.

In some arrangements, clamp tube 146 comprises body 148 which generally takes a rectangular-like tube configuration having engagement cavity 174 therein. Body 148, although preferably rectangular in configuration, may take alternative configurations, such as cylindrical. Second pair of attachment arms 150 is fixedly secured to body 148 proximate axial direction AD1 and a portion thereof preferably surrounds a majority of body 148 at an end in axial direction AD1. Clamp 152 is fixed to one or more of each arm of Second pair of attachment arms 150 or a bottom surface of body 148. Clamp 152 includes channel 162 having an opening thereto, which opening is shown substantially parallel to the respective opens of engagement cavity 174.

Fastener apertures 176 and 178 are arranged proximate respective ends of clamp 152 and are in communication with channel 162, i.e., apertures 176 and 178 open into channel 162. In a preferred embodiment, fastener apertures 176 and 178 are threaded. Attachment fasteners 180 and 182 are arranged to removably engage fastener apertures 176 and 178, respectively, such that respective terminating ends of fasteners 180 and 182 may be protruding into channel 162 of clamp 152 (when the fasteners are threaded into channel 152 via their respective apertures)-thereby allowing clamp 152 to removably and frictionally secure to box blade 120 (See FIGS. 10-12). In other words, fasteners 180 and 182 are preferably threaded into apertures 176 and 178 such that the protruding ends are within channel 162 and contact top lip 134, sandwiching top lip 134 between the protruding ends of fasteners 180 and 182, and clamp 152. In a preferred embodiment, attachment fasteners 180 and 182 are threaded. Body 148 includes plurality of securement apertures 184 arranged within the respective surfaces of body 148, where each securement aperture is in communication with engagement cavity 174, i.e., each securement aperture is open to engagement cavity 174. It should be appreciated that the number and/or position of securement apertures of body 148 is variable and can be altered accordingly in order to allow one or more of clamp tube 146 or hitch section 154 to be telescopingly and removably secured within body 142.

In some designs, distal tube 164 is secured between second pair of attachment arms 150, preferably proximate distal ends of each attachment arm. Distal tube 164 comprises body 166 which generally takes a rectangular-like tube configuration having engagement cavity 186 therein. Body 166, although preferably rectangular in configuration, may take alternative configurations, such as cylindrical, so long as body 166 of distal tube 164 may removably accept another tube, e.g., one or more of body 158 of hitch section 154, body 190 of ancillary tube 168, or another body of an implement adapted to be removably connected within a tow-hitch receiver. Thus, in a preferred embodiment, a perimeter of engagement cavity 186 of body 166 is greater than an outer perimeter of both body 158 of hitch section 154 and body 190 of ancillary tube 168 (or any other implement adapted to be removably connected within a tow-hitch receiver), thereby allowing the inserted body to translate within body 166. Body 166 includes a plurality of securement apertures 186 arranged within the respective surfaces of body 166, where each securement aperture is in communication with engagement cavity 186, i.e., each securement aperture is open to the engagement cavity. It should be appreciated that the number and/or position of securement apertures of body 166 is variable and can be altered accordingly in order to allow one or more of hitch section 154, ancillary tube, or an implement adapted to be removably connected within a tow-hitch receiver, to be telescopingly and removably secured within body 166.

Hitch section 154 may comprise body 158 which generally is configured as rectangular-like tube, which may be either substantially hollow, as shown, or could be a solid piece. Preferably, an outer perimeter of body 158 is less than a perimeter of engagement cavity 174 of body 148 of clamp tube 146, such that body 158 of hitch section 154 may be inserted within body 148 and translate therein. Hitch tongue 160 extends from a terminating end of bod 158 and is similar in construction to hitch tongue 86 (See FIGS. 5 and 6, described supra) such that hitch ball 156 may be removably secured within hitch tongue 160. Hitch ball 156, e.g., a “trailer ball” and/or “tow ball”, is a substantially spherical attachment that allows a trailer tongue to engage tow hitch attachment 138—allowing the trailer tongue to pivot on the hitch ball. Body 158 includes a plurality of securement apertures 198 arranged within the respective surfaces of body 158, where each securement aperture is in communication with engagement cavity 196, i.e., each securement aperture is open to the engagement cavity. It should be appreciated that the number and/or position of securement apertures of body 158 is variable and can be altered accordingly in order to allow hitch section 154 to be telescopingly and removably secured within one or more of distal tube 164, clamp tube 146, or main tube 140.

In a preferred arrangement, one or more of main tube 140, clamp tube 146, and hitch section 154 are removably secured by securement pin 200, where one or more of hitch section 154 or ancillary tube 168 are removably secured within distal tube 164 by securement pin 202. Each of securement pins 200 and 202 are arranged to accept locking pins 204 and 206, respectively, thereby preventing securement pins 200 and 202 from being removed from the colinear plurality of securement apertures of one or more tubes-generally illustrated in FIGS. 10 through 12.

The following description is in reference to FIGS. 10 through 13B. To assemble tow hitch attachment 138, body 148 of clamp tube 146 is inserted within an opening of engagement cavity 170 of body 142 of main tube 140 proximate first pair of attachment arms 144. Body 148 is removably secured within engagement cavity 170 via securement pin 200, wherein securement pin 200 is removably seated within a respective colinear pair of securement apertures 172 of body 142 of main tube 140 and also within a respective colinear pair of securement apertures 184 of body 148 of clamp tube 146. Thus, depending on the particular colinear pair of securement apertures 172 and 184 of main tube 140 and clamp tube 146, respectively, the distance between first pair of attachment arms 144 and clamp 152 is adjustable. Similarly, securement pin 200 may also engage a respective colinear pair of securement apertures 198 of body 158 of hitch section 154, to secure body 158 of hitch section 154 within both of engagement cavity 174 of body 148 of clamp tube 146 and within engagement cavity 170 of body 142 of main tube 140, thereby removably connecting hitch section 154 within main tube 140. Securement pin 202 interacts similarly, such that it engages a colinear pair of securement apertures 188 of body 166 of distal tube 164 and one or more of a colinear pair of securement apertures 198 of body 158 of hitch section 154, a colinear pair of securement apertures 194 of body 190 of ancillary tube 168, or a colinear pair of securement apertures of an implement adapted to be removably connected within a tow-hitch receiver, to be telescopingly and removably secured within body 166 via securement pin 202.

In reference to FIGS. 10 through 12, when an accessory or implement is engaged to hitch ball 156 for towing, when box blade 120 moves in axial direction AD2, the accessory (when engaged) will pull tow hitch attachment in the opposite direction, axial direction AD1, forcing top lip 134 to abut clamp 152 within channel 162, thereby forcing plate 132 to abut first pair of attachment arms 144—fictionally securing tow hitch attachment 138 to box blade 120 (via the generally described force vectors). Thus, when force is applied to blade 120 in axial direction AD2 and force is applied to tow hitch attachment 138 in axial direction AD1, tow hitch attachment 138 is forcibly secured to box blade 120 and cannot be removed. When no force (in either axial directions AD1 and AD2) is applied to box blade 120 and no force (in either axial directions AD1 and AD2) is applied to tow hitch attachment 138, tow hitch attachment 138 is still attached to box blade 120 via the “pinching” arrangement of clamp 152 and first pair of attachment arms 144.

Lastly, one having ordinary skill should appreciate that the medial section or clamp tube of the various embodiments of the present invention is arranged to accept a plurality of different hitch-tongues and/or hitch sections within its engagement cavity, allowing a plurality of available commercial options to be readily interchangeable with the tow hitch attachment disclosed herein. As such, in some embodiments of the tow hitch attachment of the present invention, the tow hitch attachment may comprise one or more of the clamp section and the medial section or the main tube and the clamp tube.

Notwithstanding the description and exemplary illustrations, it should be noted that the present invention, in its various embodiments and alternative configurations, can be affixed to a variety of implements which have structural arrangements which allow the clamp and attachment arms of the tow hitch attachment to be pinched thereon.

### EXAMPLES

Various examples of the inventive concept are provided below.

Example 1—A mounting assembly for a tow hitch, comprising: a clamp section; a medial section; and, a hitch section arranged to removably accept a hitch-ball therein, wherein the medial section slidably engages the clamp section and the hitch section slidably engages the medial section.

Example 2—The mounting assembly for a tow hitch recited in Example 1, wherein the clamp section includes: a main body defining an inner engagement cavity, the main body having a plurality of securement apertures therein; and, a C-shaped clamp extending from the main body, the C-shaped clamp have a pair of fasteners attached thereto.

Example 3—The mounting assembly for a tow hitch recited in Example 1, wherein the medial section includes a main body defining an inner engagement cavity, the main body having a plurality of securement apertures arranged therein, the main body having a pair of attachment arms extending from the main body.

Example 4—The mounting assembly for a tow hitch recited in Example 1, wherein the hitch section includes an attachment body having a pair of attachment apertures arranged proximate a first end and a hitch-ball aperture arranged at a second end, wherein a hitch-ball is arranged to be removably secured within the hitch-ball aperture.

Example 5—The mounting assembly for a tow hitch recited in Examples 2 through 4, wherein the main body of the medial section is arranged to be seated within the main body of the clamp section and wherein the attachment body of the hitch section is arranged to be seated within the main body of the medial section.

Example 6—A mounting assembly for a tow hitch, comprising: clamp section, including: a main body defining an inner engagement cavity, the main body having a plurality of securement apertures therein; and, a C-shaped clamp extending from the main body, the C-shaped clamp have a pair of fasteners attached thereto; a medial section having a main body defining an inner engagement cavity, the main body of the medial section have a plurality of securement apertures arranged therein, a pair of attachment arms extending from the main body of the medial section; and, a hitch section having an attachment body, the attachment body having a pair of attachment apertures arranged proximate a first end and a hitch-ball aperture arranged at a second end, a hitch-ball is arranged to be removably secured within the hitch-ball aperture, wherein the main body of the medial section is arranged to be seated within the inner engagement cavity of the main body of the clamp section and the attachment body of the hitch section is arranged to be seated within the inner engagement cavity of the medial section.

Example 7—The mounting assembly for a tow hitch recited in Example 6, wherein a first securement pin is arranged to removably engage a pair of securement apertures of the plurality of securement apertures of the clamp section and the first securement pin is further arranged to removably engage a pair of securement apertures of the plurality of securement apertures of the medial section, wherein a second securement pin is arranged to engage a second pair of apertures of the plurality of securement apertures of the plurality of securement apertures of the medial section and the second securement pin is further arranged to removably engage the pair of attachment apertures of the hitch section, such that the first and second securement pins removably connected the clamp section, the medial section, and the hitch section.

Example 8—The mounting assembly for a tow hitch recited in Example 6, wherein the C-shaped clamp is arranged to accept an edge of a tractor blade therein and the pair of attachment arms are arranged to abut a surface of the tractor blade, removably securing the tow hitch thereto.

Example 9—A mounting assembly for a tow hitch, comprising: a first tube having a C-shaped clamp extending therefrom, the C-shaped clamp having a pair of attachment fasteners removably secured thereto; a second tube arranged to telescopingly and removably insert into the first tube, the second tube having a pair of attachment arms extending therefrom; a hitch body having a first end and second end, the first end arranged to telescopingly and removably insert into the second tube, the second end having a hitch-ball aperture arranged proximate the second end, the hitch-ball aperture having a hitch-ball removably inserted therein.

Example 10—The mounting assembly for a tow hitch recited in Example 9, wherein the C-shaped clamp is arranged to accept an edge of a tractor blade therein and the pair of attachment arms are arranged to abut a first surface of the tractor blade, removably securing the tow hitch thereto.

Example 11—The mounting assembly for a tow hitch recited in Example 10, wherein the pair of attachment fasteners are operatively arranged to frictionally secure the edge of the tractor blade within the C-shaped clamp when the pair of attachment fasteners are abutting a second surface of the tractor blade.

Example 12—The mounting assembly for a tow hitch recited in Example 9, wherein the first tube includes a first plurality of apertures and the second tube includes a second plurality of apertures, wherein a first securement pin locks the second tube within the first tube when arranged within a colinear pair of the first plurality of apertures and a colinear pair of the second plurality of apertures.

Example 13—The mounting assembly for a tow hitch recited in Example 12, wherein the second tube includes a first pair of apertures arranged opposite the second plurality of apertures and the hitch body includes a second pair of apertures proximate the first end, wherein a second securement pin locks the first end of the hitch body within the second tube when arranged within the first pair of apertures and the second pair of apertures.

Example 14—A mounting assembly for a tow hitch, comprising: a main body having a hitch tongue removably secured to and extending from a first end, the hitch tongue having an aperture arranged therein; a pair of attachment arms extending downwardly from the main body and arranged proximate the first end; and, a clamp secured to the main body and proximate a second end of the main body, the clamp having a channel therein, the channel having an opening and substantially facing a downward direction, wherein the clamp and the pair of attachment arms are spaced apart and a distance therebetween is adjustable, wherein the aperture of the hitch tongue is arranged to accept a hitch-ball therein.

Example 15—The mounting assembly for a tow hitch recited in Example 14, wherein the clamp is arranged to accept an edge of a blade therein and the attachment arms are arranged to abut a surface of the blade, thereby frictionally and removably securing the main body to the blade.

Example 16—The mounting assembly for a tow hitch recited in claim 14, wherein the main body comprises: a clamp section having a first tube and a first engagement cavity therein, the clamp fixedly secured to the first tube; a medial section having a second tube and a second engagement cavity therein, the attachment arms extending from the second tube; and, a hitch section having the hitch tongue extending therefrom, wherein: the second tube of the medial section is arranged to be slidably and removably secured at least partially within the first engagement cavity; and, the hitch section is arranged to be slidably and removably secured at least partially within the second engagement cavity.

Example 17—The mounting assembly for a tow hitch recited in Example 15, wherein the blade is a rear blade.

Example 18—The mounting assembly for a tow hitch recited in Example 14, wherein the clamp is substantially C-shaped.

Example 19—A mounting assembly for a tow hitch, comprising: a main body having a first end and a second end, the main body having at least one engagement cavity therein; a pair of attachment arms extending downwardly from the main body and arranged proximate the first end; and, a clamp secured to the main body and proximate a second end of the main body, the clamp having a channel therein, the channel having an opening and substantially facing a downward direction, wherein the clamp and the pair of attachment arms are spaced apart and a distance therebetween is adjustable.

Example 20—The mounting assembly for a tow hitch recited in Example 19, wherein the engagement cavity is arranged to removably accept a hitch tongue therein.

Example 21—The mounting assembly for a tow hitch recited in Example 19, wherein the clamp is arranged to accept an edge of a substantially planar object therein and the attachment arms are arranged to abut a surface of the substantially planar object, thereby frictionally and removably securing the main body to the substantially planar object.

Example 22—The mounting assembly for a tow hitch recited in Example 21, wherein the substantially planar object is a rear blade.

Example 23—The mounting assembly for a tow hitch recited in Example 19, wherein the main body comprises: a clamp section having a first tube and a first engagement cavity therein, the clamp fixedly secured to the first tube; a medial section having a second tube and a second engagement cavity therein, the attachment arms extending from the second tube; and, wherein: the second tube of the medial section is arranged to be slidably and removably secured at least partially within the first engagement cavity.

Example 24—The mounting assembly for a tow hitch recited in Example 23, wherein the second engagement cavity is further arranged to removably accept a body of a hitch tongue therein.

Example 25—A mounting assembly for a tow hitch, comprising: a first tube having a having a pair of attachment arms extending therefrom; a second tube arranged to telescopingly and removably insert into the first tube, the second tube having a second pair of attachment arms extending therefrom, a C-shaped clamp extending from the second pair of attachment arms; and, a hitch body having a first end and second end, the first end arranged to telescopingly and removably insert into the second tube, the second end having a hitch-ball aperture arranged proximate the second end, wherein the hitch-ball aperture is adapted to removably accept a hitch-ball therein.

Example 26—The mounting assembly recited in Example 25, wherein the C-shaped clamp has a pair of attachment fasteners removably secured thereto.

Example 27—The mounting assembly for a tow hitch recited in claim 25, wherein the C-shaped clamp is arranged to accept an edge of a substantially planar object therein and the attachment arms are arranged to abut a surface of the substantially planar object, thereby frictionally and removably securing the first body to the substantially planar object.

Example 28—The mounting assembly for a tow hitch recited in claim 27, wherein the substantially planar object is a box blade.

Example 29—The mounting assembly for a tow hitch recited in claim 25 further comprising: a third tube attached to and arranged substantially between the second pair of attachment arms proximate distal ends of the second pair of attachment arms, the third tube adapted to telescopingly and removably accept one or more of the hitch body therein or a fourth tube therein.

Example 30—A mounting assembly for a tow hitch, comprising: a pair of tubes, one of the pair of tubes arranged to be inserted within the other of the pair of tubes and selectively telescope therein; a C-shaped clamp extending from one of the pair of tubes; and, a pair of attachment arms extending from one of the pair of tubes without the C-shaped clamp; wherein the C-shaped clamp and the pair of attachment arms are adapted to be selectively translated together, thereby securing a planar object within the C-clamp via the pair of attachment arms abutting the planar object.

Example 31—The mounting assembly for a tow hitch recited in claim 30 further comprising: a hitch body having a first end and second end, the first end arranged to telescopingly and removably insert into at least one tube of the pair of tubes, the second end having a hitch-ball aperture arranged proximate the second end, wherein the hitch-ball aperture is adapted to removably accept a hitch-ball therein.

Example 32—The mounting assembly for a tow hitch recited in claim 30 further comprising: a second pair of attachment arms extending from one of the pair of tubes, the C-shaped clamp affixed to the second pair of attachment arms.

Example 33—The mounting assembly for a tow hitch recited in claim 32, wherein the second pair of attachment arms are angled.

Example 34—The mounting assembly for a tow hitch recited in claim 30, wherein the C-shaped clamp has a pair of attachment fasteners removably secured thereto.

Example 35—The mounting assembly for a tow hitch recited in claim 32 further comprising: a distal tube attached to and arranged substantially between the second pair of attachment arms proximate distal ends of the second pair of attachment arms, the distal tube adapted to telescopingly and removably accept one or more of the hitch body therein or another tube therein.

Example 36—The mounting assembly for a tow hitch recited in claim 30, wherein an opening of a channel of the C-shaped clamp is substantially parallel to one or more openings of the pair of tubes.

Example 37—The mounting assembly for a tow hitch recited in claim 30 further comprising: at least one securement pin, the securement pin arranged to be inserted within a colinear pair of apertures of a plurality of apertures arranged within both of the pair of tubes, thereby securing one of the pair of tubes within the other of the pair of tubes.

It should be noted that the various embodiments disclosed herein, may be arranged in various combinations according to any of the embodiments shown and described. As such, the shown and described embodiments are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Rear blade
12 Three-point hitch attachment apparatus
14 Blade
16 Top edge
18 Bottom edge
20 Side edge
22 Side edge
24 First surface
26 Second surface
30 Tow hitch attachment
32 Clamp section
34 Medial section
36 Hitch section
38 Hitch-ball
40 Clamp
42 Attachment arms
44 Main body
46 Engagement cavity
48 Attachment frame
50 Angled extension
52 Angled extension
54 Channel
56 Fastener aperture
58 Fastener aperture
60 Attachment fastener
62 Attachment fastener
64 Plurality of securement apertures
64a-64d Securement aperture
66 Plurality of securement apertures
66a-66d Securement aperture
68 Main body
70 Engagement cavity
72 Attachment frame
74 Plurality of securement apertures
74a-74c Securement aperture
76 Plurality of securement apertures
76a-76c Securement aperture
78 Securement aperture
80 Securement aperture
82 Attachment body
84 Extension
86 Hitch tongue
88 Hitch-ball aperture
90 Securement aperture
92 Securement aperture
94 Securement pin
96 Securement pin
98 Locking pin
100 Locking pin
102 Threaded portion
104 Nut
106 Washer
108 Pin aperture
110 Pin aperture
120 Box blade
122 Three-point hitch apparatus
124 Support member
126 Scarifier/Shank
128 Side member
130 Side member
132 Plate
134 Top lip
136 Blade
138 Tow hitch attachment
140 Main tube
142 Body
144 First pair of attachment arms
146 Clamp tube
148 Body
150 Second pair of attachment arms
152 Clamp
154 Hitch section
156 Hitch ball
158 Body
160 Hitch tongue
162 Channel
164 Distal tube
166 Body
168 Ancillary tube
170 Engagement cavity
172 Securement apertures
174 Engagement cavity
176 Fastener aperture
178 Fastener aperture
180 Attachment fastener
182 Attachment fastener
184 Securement apertures
186 Engagement cavity
188 Securement apertures
190 Body
192 Engagement cavity
194 Securement apertures
196 Engagement cavity
198 Securement apertures
200 Securement pin
202 Securement pin
5 204 Locking pin
206 Locking pin
AD1 Axial direction
AD2 Axial direction
RD1 Radial direction
RD2 Radial direction

What is claimed is:

1. A mounting assembly for a tow hitch, comprising:
a first tube having a C-shaped clamp extending therefrom, said C-shaped clamp having a pair of attachment fasteners removably secured thereto;
a second tube arranged to telescopingly and removably insert into said first tube, said second tube having a pair of attachment arms extending therefrom;
a hitch body having a first end and second end, said first end arranged to telescopingly and removably insert into said second tube, said second end having a hitch-ball aperture arranged proximate said second end, said hitch-ball aperture adapted to removably accept a hitch-ball therein.

2. The mounting assembly for a tow hitch recited in claim 1, wherein said C-shaped clamp is arranged to accept an edge of a tractor blade therein and said pair of attachment arms are arranged to abut a first surface of said tractor blade, removably securing said tow hitch thereto.

3. The mounting assembly for a tow hitch recited in claim 2, wherein said pair of attachment fasteners are operatively arranged to frictionally secure said edge of said tractor blade within said C-shaped clamp when said pair of attachment fasteners are abutting a second surface of said tractor blade.

4. The mounting assembly for a tow hitch recited in claim 1, wherein said first tube includes a first plurality of apertures and said second tube includes a second plurality of apertures, wherein a first securement pin locks said second tube within said first tube when arranged within a colinear pair of said first plurality of apertures and a colinear pair of said second plurality of apertures.

5. The mounting assembly for a tow hitch recited in claim 4, wherein said second tube includes a first pair of apertures arranged opposite said second plurality of apertures and said hitch body includes a second pair of apertures proximate said first end, wherein a second securement pin locks said first end of said hitch body within said second tube when arranged within said first pair of apertures and said second pair of apertures.

6. The mounting assembly for a tow hitch recited in claim 1, wherein said clamp is arranged to accept an edge of a substantially planar object therein and said attachment arms are arranged to abut a surface of said substantially planar object, thereby frictionally and removably securing said first body to said substantially planar object.

7. The mounting assembly for a tow hitch recited in claim 6, wherein said substantially planar object is a rear blade.

8. A mounting assembly for a tow hitch, comprising:
a first tube having a having a pair of attachment arms extending therefrom;
a second tube arranged to telescopingly and removably insert into said first tube, said second tube having a second pair of attachment arms extending therefrom, a C-shaped clamp extending from said second pair of attachment arms; and,
a hitch body having a first end and second end, said first end arranged to telescopingly and removably insert into said second tube, said second end having a hitch-ball aperture arranged proximate said second end, wherein said hitch-ball aperture is adapted to removably accept a hitch-ball therein.

9. The mounting assembly recited in claim 8, wherein said C-shaped clamp has a pair of attachment fasteners removably secured thereto.

10. The mounting assembly for a tow hitch recited in claim 8, wherein said C-shaped clamp is arranged to accept an edge of a substantially planar object therein and said attachment arms are arranged to abut a surface of said substantially planar object, thereby frictionally and removably securing said first body to said substantially planar object.

11. The mounting assembly for a tow hitch recited in claim 10, wherein said substantially planar object is a box blade.

12. The mounting assembly for a tow hitch recited in claim 8 further comprising:
a third tube attached to and arranged substantially between said second pair of attachment arms proximate distal ends of said second pair of attachment arms, said third tube adapted to telescopingly and removably accept one or more of said hitch body therein or a fourth tube therein.

13. A mounting assembly for a tow hitch, comprising:
a pair of tubes, one of the pair of tubes arranged to be inserted within the other of the pair of tubes and selectively telescope therein;
a C-shaped clamp extending from one of the pair of tubes; and,
a pair of attachment arms extending from one of the pair of tubes without the C-shaped clamp;
wherein the C-shaped clamp and the pair of attachment arms are adapted to be selectively translated together, thereby securing a planar object within the C-clamp via the pair of attachment arms abutting the planar object.

14. The mounting assembly for a tow hitch recited in claim 13 further comprising:
a hitch body having a first end and second end, the first end arranged to telescopingly and removably insert into at least one tube of the pair of tubes, the second end having a hitch-ball aperture arranged proximate said second end, wherein the hitch-ball aperture is adapted to removably accept a hitch-ball therein.

15. The mounting assembly for a tow hitch recited in claim 13 further comprising:
a second pair of attachment arms extending from one of the pair of tubes, the C-shaped clamp affixed to the second pair of attachment arms.

16. The mounting assembly for a tow hitch recited in claim 15, wherein the second pair of attachment arms are angled.

17. The mounting assembly for a tow hitch recited in claim 13, wherein the C-shaped clamp has a pair of attachment fasteners removably secured thereto.

18. The mounting assembly for a tow hitch recited in claim 15 further comprising:
a distal tube attached to and arranged substantially between said second pair of attachment arms proximate distal ends of said second pair of attachment arms, said distal tube adapted to telescopingly and removably accept one or more of the hitch body therein or another 5 tube therein.

19. The mounting assembly for a tow hitch recited in claim 13, wherein an opening of a channel of the C-shaped clamp is parallel to one or more openings of the pair of tubes.

20. The mounting assembly for a tow hitch recited in claim 13 further comprising:
at least one securement pin, the securement pin arranged to be inserted within a colinear pair of apertures of a plurality of apertures arranged within both of the pair of tubes, thereby securing one of the pair of tubes within the other of the pair of tubes.
